(19) United States
(12) Patent Application Publication
(10) Pub. No.: US 2010/0106128 A1
(43) Pub. Date: Apr. 29, 2010

(54) CONTACT LENS CASES FOR DELIVERY OF OPHTHALMIC AGENTS

(76) Inventors: Shane Mao, Pittsford, NY (US); Joseph Barr, Dublin, OH (US); X. Michael Liu, Pittsford, NY (US); Suzanne F. Groemminger, Rochester, NY (US)

Correspondence Address: Bausch & Lomb Incorporated, One Bausch & Lomb Place, Rochester, NY, 14604-2701, US

(21) Appl. No.: 12/256,526

(22) Filed: Oct. 23, 2008

(51) Int. Cl. A61J 1/14; A45C 11/04

(52) U.S. Cl. 604/411; 206/5.1; 604/415

(57) ABSTRACT

Contact lens cases for delivering ophthalmic active agents to contact lenses. A contact lens case includes a container defining a reservoir for soaking a contact lens in a solution, and a lid assembly that may be secured to the container for closing the reservoir. The lid assembly includes a lid and a dispenser pack. The dispenser pack includes one or more compartments containing a treatment unit which may be dispensed from the compartment(s) into the solution. After the contact lens soaks in solution and retains or absorbs a suitable amount of the ophthalmic agent from the treatment unit, the contact lens is inserted in a user's eye for treating the eye.

### TECHNICAL FIELD

The invention is directed to contact lens cases, and in particular, to the delivery of ophthalmic active agents to the eyes by means of contact lenses.

### BACKGROUND

Current methods of delivering ophthalmic active agents, i.e., both pharmaceutical and non-pharmaceutical agents, to treat ocular disorders and diseases are somewhat inefficient and cumbersome. For example, ninety percent of current ophthalmic active agents are provided in drops or ointments, which typically have low absorption rates. In fact, usually less than seven percent of the applied active agent is absorbed by eye tissue. Due to low absorption rates, drops and ointments must include high dosages of active agent(s), and multiple dosages often must be applied in order for the active agent(s) to be effective. Additionally, side effects, such as heart problems, can result when using eye drops because the active agent(s) in the drops can seep into the nasal cavity and then into the bloodstream and other tissues.

Convenience for the patient, and consequently, patient compliance in administering the ophthalmic agents is also an issue to be considered. For example, a person may need to transport one or more containers (such as bottles or tubes) containing eye drop solution or eye ointment to ensure that appropriate treatments are applied at specific times during a day. Also, the person will likely have to administer the drops every two to four hours because of the low absorption rates and tear wash out. Not only is this an inconvenience, but the person may forget or miss one or two treatments each day.

It is therefore desirable to provide a more effective and convenient system for delivering ophthalmic active agents to the eye. More specifically, it is desirable to provide a system that delivers ophthalmic agents to the eye via a contact lens.

### SUMMARY

Contact lens cases for delivering ophthalmic agents to contact lenses are described. The ophthalmic agents are then delivered to the eyes by the way of the contact lenses as the agents are introduced to the contact lenses prior to insertion. According to one embodiment, a contact lens case comprises a container defining a reservoir for holding a contact lens solution and a contact lens, and a first lid assembly for attachment to the container. The lid assembly includes a lid attachable to the container for closing the reservoir, and a dispenser pack that is attachable top the lid. The dispenser pack comprises at least one compartment containing a treatment unit for dispensing into the reservoir. The reservoir would also contain a lens solution. The treatment unit is dispensed into the reservoir for mixing or dissolving into the solution. A contact lens is allowed to soak in the reservoir to absorb or retain at least a portion of the solution and a quantity of an ophthalmic agent from the treatment unit. The contact lens is subsequently placed on an eye for administering at least some of the ophthalmic agent to an eye for treatment.

According to another embodiment, a contact lens case includes a container defining a reservoir for holding a solution and a contact lens, and a one-piece lid for attachment to the container and closing the reservoir. The lid includes at least one compartment containing a treatment unit for dispensing into the reservoir and delivery of a quantity of an ophthalmic agent from the treatment unit to the contact lens.

Another embodiment includes a contact lens case with two containers and two lid assemblies or lids corresponding to the two containers, thereby enabling the storage of two contact lenses and the treatment of two eyes at the same time.

Another embodiment includes a contact lens kit includes a contact lens case and multiple dispenser packs containing treatment units. The packs are individually attachable to the lid(s) of the case, thereby allowing dispenser packs that have been depleted of treatment units to be replaced without replacing the case.

According to further embodiments, a contact lens kit includes a case having multiple lids containing treatment units. The lids are individually attachable to the container(s) of the case, thereby allowing lids that have been depleted of treatment units to be replaced without replacing the entire case.

Further features and advantages of the invention will be apparent upon reference to the following description, appended drawings, and claims.

### BRIEF DESCRIPTION OF THE DRAWINGS

FIG. 1 is a perspective view of a contact lens case according to one embodiment of the invention;

FIG. 2 is an exploded side cross-sectional view of the contact lens case of FIG. 1;

FIG. 3 is a top view of the contact lens case of FIG. 1;

FIG. 4 is a side cross-sectional view of a lid assembly of the contact lens case of FIG. 1;

FIGS. 5, 6 and 7 are top, side cross-sectional and bottom views, respectively, of a dispenser pack of the lid assembly of FIG. 4;

FIG. 8 is a partially transparent perspective view of a contact lens case according to another embodiment of the invention;

FIG. 9 is a perspective view of a lid assembly for a contact lens case according to another embodiment of the invention;

FIG. 10 is a side cross-sectional view of the lid assembly of FIG. 9.

FIG. 11 is a perspective view of a lid for a contact lens case according to another embodiment of the invention;

FIG. 12 is a side cross-sectional view of the lid of FIG. 11;

FIG. 13 shows a bottom side of the lid of FIG. 11;

FIG. 14 is an enlarged partial view of a dispenser pack for a lid assembly according to another embodiment of the invention; and

FIG. 15 is an enlarged partial view of a lid for a contact lens case according to yet another embodiment of the invention.

FIG. 16 is a side view showing a dispenser pack disposed on a contact lens case, according to another embodiment.

FIG. 17 is a side view showing a dispenser pack disposed on a contact lens case, according to yet another embodiment.

FIG. 18 is a side view of a “vertical” contact lens case according to another embodiment.

FIG. 19 is a side cross-sectional view of a base of the contact lens case of FIG. 18.

### DETAILED DESCRIPTION

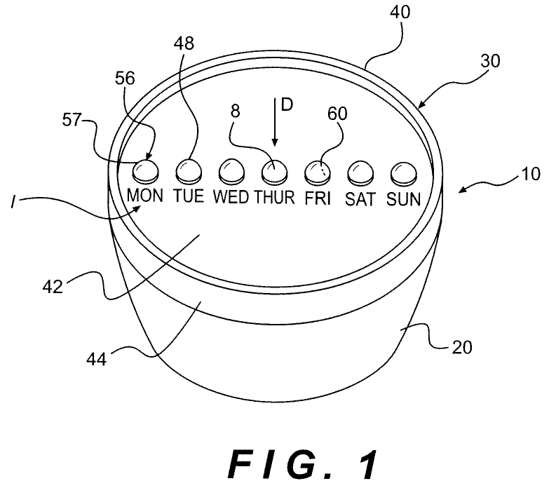

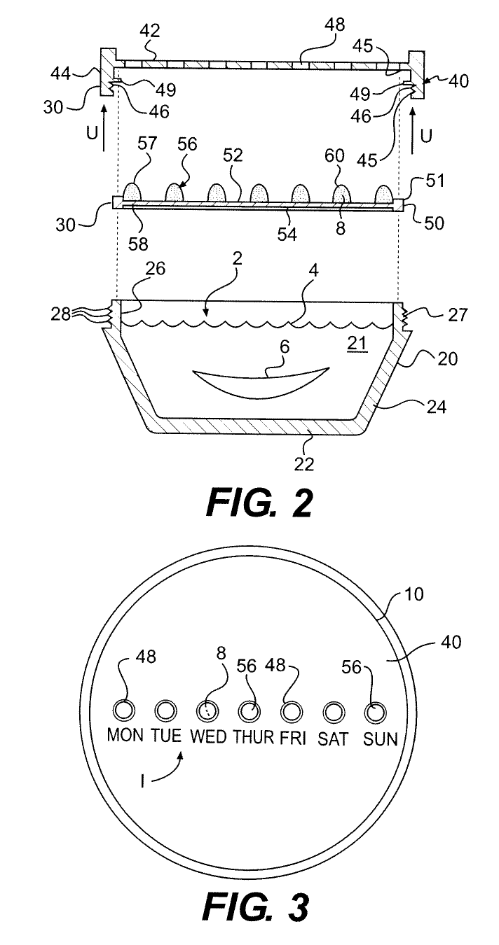

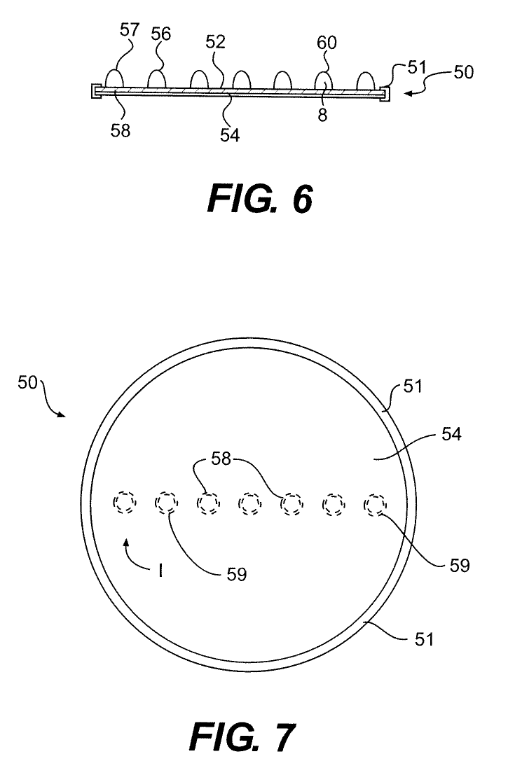

A contact lens case 10 according to one embodiment is illustrated in FIGS. 1-7. The case 10 includes a container 20 and a removable lid assembly 30 for attachment to the container 20. Referring to FIG. 2, the lid assembly 30 includes a lid 40 and a dispenser pack, or blister pack 50 sized and configured to fit inside the lid 40.

Still referring to FIG. 2, the container 20 may be constructed of a rigid material such as plastic, and includes a bottom wall 22 and a generally annular side wall 24 extending from the bottom wall 22. The bottom wall 22 and side wall 24 define an internal reservoir or cavity 2, which is suitable for holding solution 4 and a contact lens 6 in the solution 4. A lid engaging portion 26 is defined at the top of the side wall 24. A plurality of external threads 28 are provided on an external side 27 of the lid engaging portion 26. The container 20 may be constructed of plastic, however other materials providing suitable weight, durability and rigidity may be used.

Referring to FIGS. 2-4, the lid 40 includes a top wall 42 and an annular side wall 44 extending from the top wall 42. The top wall 42 includes a plurality of openings 48. A plurality of internal threads 46 are provided on an internal surface 45 of the side wall 44, and are designed to engage the external threads 28 to allow the lid 40 to be threaded onto and off of the container 20 to cover and uncover, respectively, the reservoir 2. A retaining ledge 49 extends from the internal surface 45. The retaining ledge 49 may comprise a continuous annular projection or a plurality of spaced projections. The lid 40 may be constructed of plastic or another material that has a suitable weight, durability and rigidity.

According to alternate embodiments (not shown), the threads 46 on the lid 40 and the threads 28 on the lid engaging portion 26 of the container 20 may be eliminated, and the lid 40 may be configured to fit onto the lid-engaging portion 26 by being pressed or snapped onto the lid engaging portion 26 with an interference or friction fit.

As shown in FIGS. 5-7, the dispenser pack 50 is a substantially disc-shaped member formed by an upper sheet of material 52 attached to a lower sheet of material 54. The pack 50 includes a plurality of bubble-shaped compartments, or blisters 56 are defined by the upper sheet of material 52 and the lower sheet of material 54. More specifically, the upper sheet of material 52 defines the top walls 57 of the compartments 56, while the lower sheet of material 54 defines the bottom walls 58 (FIG. 7) of the compartments 56. The top walls 57 may be convex and the bottom walls 58 may be substantially flat, thereby defining an interior volume 60 of each compartment 56. The bottom walls 58 may include patterns of weakness 59. The patterns of weakness 59 may comprise nicks, scores, cuts, perforations or combinations thereof. In the embodiment shown, the patterns of weakness 59 are circular in shape, however patterns of different shapes and sizes may be provided. The upper sheet of material 52 may be constructed of a deformable material such as plastic, for example, and preferably a translucent or transparent plastic. The lower sheet of material 54 may be rupturable, and may be constructed of a material that is impermeable to water, such as foil or plastic.

Each compartment 56 contains a treatment unit 8 contained in its interior volume 60. The patterns of weakness 59 facilitate rupturing of the bottom walls 58 to dispense the treatment units 8 from the compartments 56.

The pack 50 may further include an annular gasket 51 positioned at the outer periphery of the pack 50 for providing a seal between the lid 40 and the container 20. The gasket 51 may cover portions of the upper and lower sheets of material 52, 54 and/or the outer peripheral edge of the pack 50. The gasket 51 may be constructed of a resilient material such as rubber, silicone, or plastic, for example.

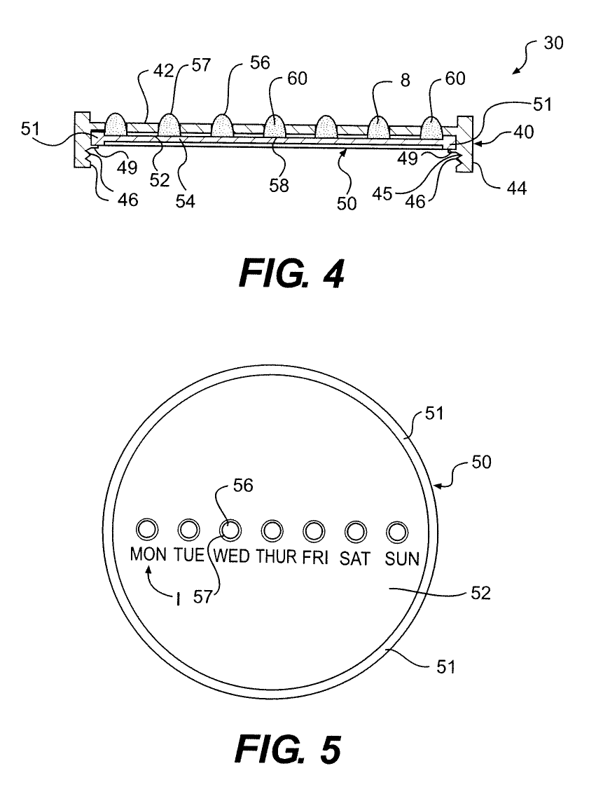

Referring to FIGS. 2 and 4, the lid assembly 30 is assembled by inserting the pack 50 through the bottom of the lid 40 (in direction U, shown in FIG. 2) inside the side wall 44, securing the peripheral edge of the pack 50 above the retaining ledge 49, aligning each compartment 56 with a respective opening 48 in the top wall 42, and fitting the top walls 57 of the compartments 56 through the openings. If the gasket 51 is provided on the pack 50, the gasket 51 forms a tight seal between the pack 50 and the lid 40. When the pack 50 is inserted into the lid 40, the top walls 57 of the compartments 56 protrude through the openings 48 and are at least partially exposed at the top of the lid 40, and the bottom walls 58 are exposed at a bottom side of the lid 40.

Once the lid assembly 30 is assembled, the lid assembly 30 may be threaded or pressed (where the lid 40 and container 20 are threadless) onto the container 20 after the solution 4 and the contact lens 6 are placed in the reservoir 2 in order to close the case 10 and prepare the case 10 for delivering a quantity of a treatment agent from a treatment unit 8 to the contact lens 6. A treatment unit 8 may be individually dispensed from a compartment 56 by pressing the top wall 57 of the compartment 56 downward (in direction D, shown in FIG. 1) such that the top wall 57 and the unit 8 move downward to thereby rupture the bottom wall 58, and release the unit 8 into the reservoir 2. After the unit 8 is released into the reservoir 2, the lens 6 is allowed to soak in the solution 4 for a period sufficient to allow the unit 8 to dissolve into or mix with the solution 4, and to allow at least some of the solution 4 and at least some of the agent from the unit 8 to be absorbed or retained by the contact lens 6. The time required for soaking will vary depending on the composition of the solution 4, the lens 6, and the form and composition of the unit 8. After soaking, the contact lens 6 may be placed in a users eye for treating the eye with the agent.

It should be noted that the treatment unit 8 may also be dispensed from a compartment 56 prior to securing the lid assembly 30 to the container 20, while the lid 40 is detached and from the container 20 and held thereabove.

Treatment units 8 may be administered to the contact lens 6 in the above-described manner at daily intervals, or at any other prescribed intervals, depending on the form and composition of the unit 8 and the condition being treated. In order to remind a user when a treatment is due, the lid 40 and/or dispenser pack 50 may include treatment identifiers or labels I (FIGS. 1, 3 and 5) on its outer surface, in the form of words, abbreviated words (such as Mon, Tue, Wed, Thur, Fri, Sat, Sun), numbers or symbols indicative of treatment days, treatment numbers or treatment times. Subsequent treatments are applied to a lens 6 by dispensing units 8 from unused compartments 56 at the prescribed time intervals. Where the upper layer 52 of the pack 50 is translucent or transparent, it is easy for a user to determine visually whether a compartment 56 is empty or whether a compartment 56 contains any undispensed units 8. In the embodiment shown, the pack 50 includes seven compartments, which is suitable for applying daily treatments over the course of one week. Once the units 8 have been dispensed from all of the compartments 56, a new pack 50 may be inserted into the lid 40.

The described contact lens cases can also be one component of a drug delivery kit. For example, a kit would include a case 10 and a plurality of packs 50 such as four packs containing seven compartments 56. The four packs would provide one month of eye treatments before the case 10 is discarded and replaced. Proper hygiene is promoted by limiting the number of packs 50, and therefore the number of eye treatments, provided with the case 10. It should be understood, however, that any number of packs 50 may be provided, and each pack 50 may be provided with any number of compartments 56, as desired.

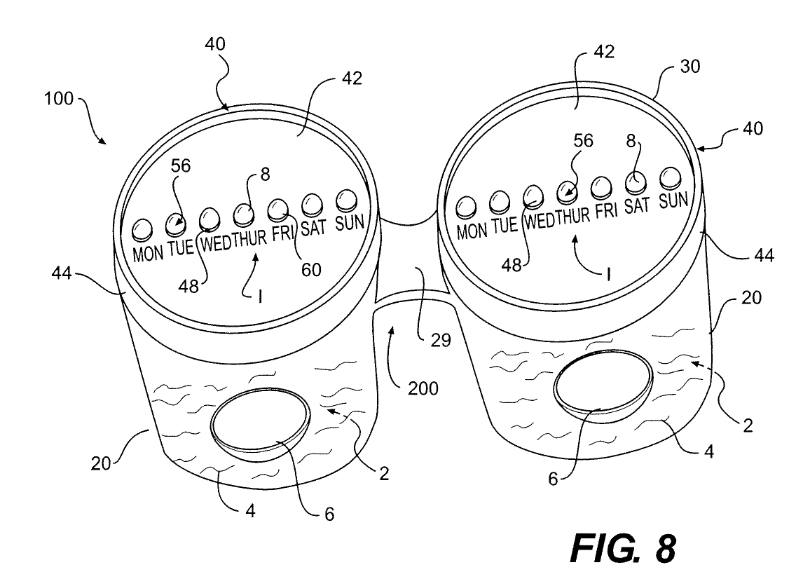

FIG. 8 shows a contact lens case 100 according to another embodiment. In FIG. 8, reference characters repeated from the description of FIGS. 1-7 indicate similar features to which the description of FIGS. 1-7 applies. The case 100 includes a base 200 having two containers 20 connected to each other by a center span 29. Each container 20 may contain solution 4 and a contact lens 6 in a reservoir 2. A pair of lid assemblies 30 are provided for attachment to the containers 20 and dispensing treatment units 8 from compartments 56 in the same manner discussed in the embodiment of FIGS. 1-7. According to this embodiment, in order to allow for approximately one-month of daily eye treatments, the case 100 may be provided with eight packs 50 (four for each eye/lid assembly 30), each containing seven compartments 56. As in the previous embodiment, any number of packs 50 may be provided, and the packs 50 may include any number of compartments 56.

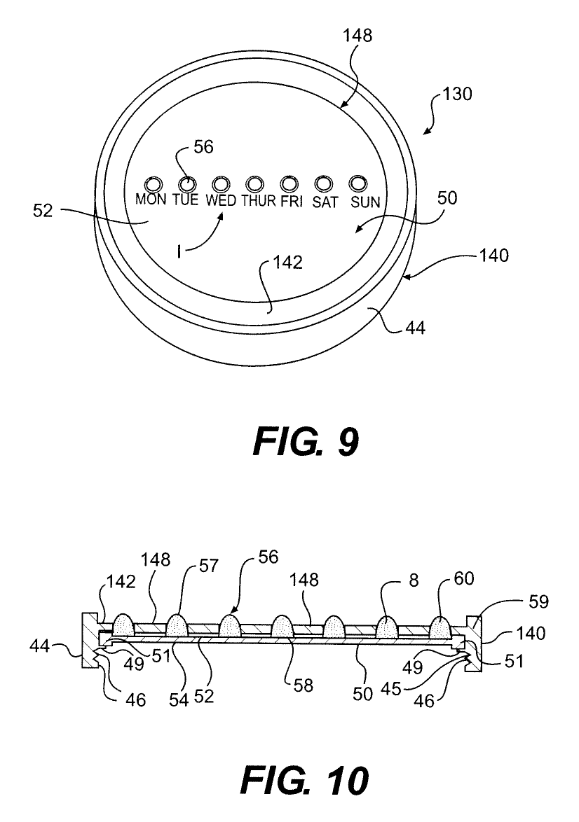

FIGS. 9 and 10 show a lid assembly 130 according to another embodiment, wherein reference numbers repeated from the lid assembly 30 of the previous embodiment indicate similar features. The lid assembly 130 includes a lid 140 and a dispenser pack 50. The lid 140 is similar to the lid 40 of the embodiments of FIGS. 1-8, except that the lid 140 has a top wall 132 with a single central opening 148 through which all of the compartments 56 are exposed on a top side of the lid 40. The lid assembly 30 is assembled in a manner similar to the way in which the previously described lid assembly 30 is assembled, except that the top walls 57 of all of the compartments 56 are inserted through the opening 148.

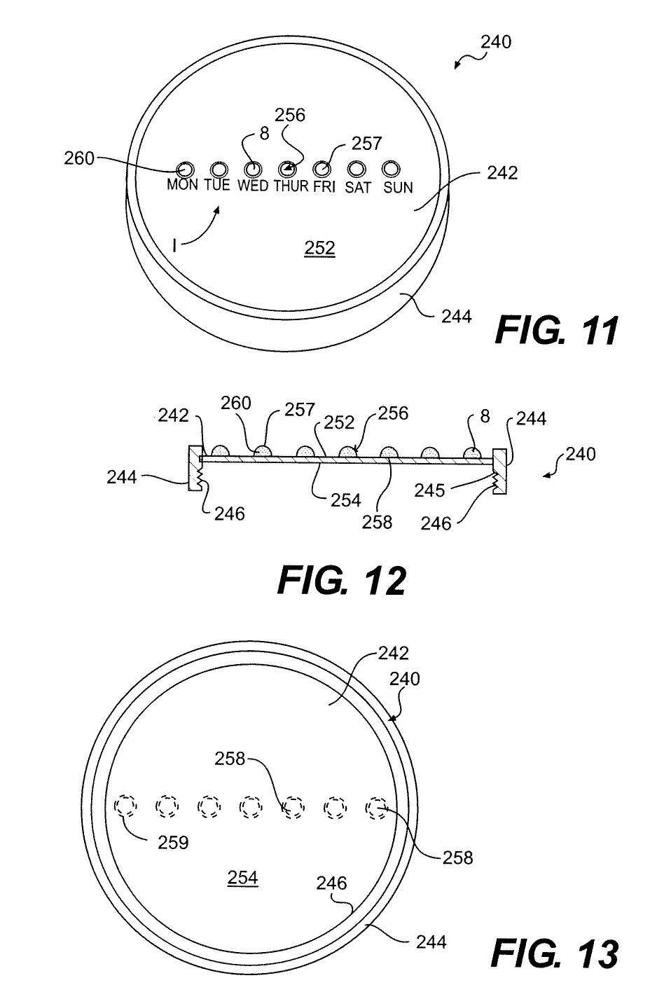

FIGS. 11-13 show a lid 240 according to another embodiment. The lid 240 may be used in place of the lid assemblies 30, 130 of the previously described embodiments. The lid 240 includes a top wall 242 and an annular side wall 244 extending from the top wall 242. The top wall 242 may be formed from an upper sheet of material 252 and a lower sheet of material 254 attached to the upper sheet of material 252 (FIG. 12). The upper sheet of material 252 may be constructed of a plastic, preferably translucent or transparent plastic, while the lower sheet of material 254 may be constructed of foil or plastic. The upper and lower sheets of material 252, 254 may be bonded to the side wall 244 such that the lid 240 is formed as a one-piece body.

A plurality of internal threads 246 are provided on an internal surface 245 of the side wall 244, and are designed to engage the external threads 28 of a container 20 as described the in the embodiments of FIGS. 1-8 in order to allow the lid 240 to engage or disengage the container 20 to cover and uncover, respectively, the reservoir 2 by turning the lid 240. As is the case with the lids 40, 140 the threads 246 may be eliminated from the lid 240 in order to provide a press-on, interference fit between the lid 240 a container 20 that lacks threads 28.

The top wall 242 includes a plurality of compartments 256 defined by the upper and lower sheets of material 252, 254. Each of the compartments 256 may contain a treatment unit 8 that can be dispensed from the compartment 256. The upper sheet of material 252 defines the top walls 257 of the compartments 256, and the lower sheet of material 254 defines the bottom walls 258 (see FIGS. 12 and 13) of the compartments 256. The top walls 257 may be convex and the bottom walls 258 may be substantially flat, thereby defining an interior volume 260. The bottom walls 58 may include patterns of weakness 259, which may comprise nicks scores, cuts, perforations or combinations thereof. Although the patterns of weakness 259 are shown circular in shape, patterns of different shapes and sizes may be provided. The upper sheet of material 252 may be constructed of a deformable material such as plastic, for example, and preferably a translucent or transparent plastic. The lower sheet of material 254 may be rupturable, and may be constructed of a material that is impermeable to water, such as foil or plastic.

The lid 240 is a one-piece alternative to the lid assemblies 30, 130 described above with respect to FIGS. 1-10. Therefore, the entire lid 240 must be replaced when the treatment units 8 have been dispensed from all of the compartments 256 in the lid 240. As in the embodiments of FIGS. 1-8, a kit containing a one-month supply of treatments for a single eye may include four lids 240, wherein each lid 240 contains seven compartments 256. A kit, for example, containing a one-month supply of treatments for two eyes may include eight lids 240, wherein each lid 240 contains seven compartments 256. However, any number of lids 240 having any number of compartments 256 may be provided, as desired.

A unit 8 can be dispensed from a compartment 256 in the same way a unit 8 is dispensed from a compartment 56 in the previous embodiments. Specifically, pressing down on the top wall 257 in the direction D will force the top wall 257 and the unit 8 downward and thereby rupture the bottom wall 258 of the compartment 256. To help ensure proper administration of treatments, the lid 240 may also include treatment identifiers or labels I (FIG. 11) on its outer surface corresponding to each compartment 256.

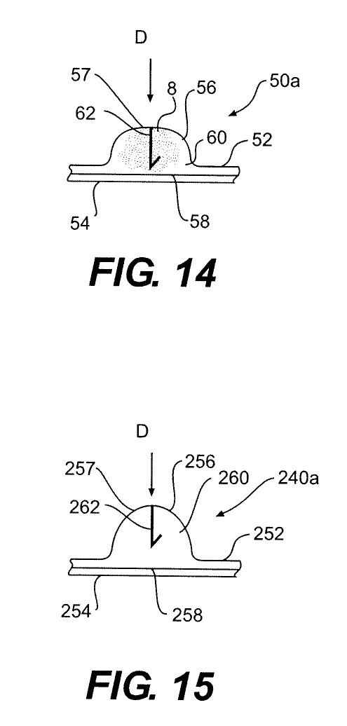

FIGS. 14 and 15 respectively show a dispenser pack 50a and a lid 240a according to further embodiments. The pack 50a and lid 240a are similar to the previously described pack 50 and lid 240, respectively, except that the compartments 56, 256 include puncturing elements 62, 262. The puncturing elements 62, 262 are attached to interior surfaces of the top walls 57, 257, and extend downward into the interior volumes 60, 260. The puncturing elements 62, 262 may each comprise a rod, pin, blade, or any other projection that is sufficiently sharp to puncture the bottom walls 58, 258. According to the embodiments of FIGS. 14 and 15, the puncturing elements 62, 262 facilitate the dispensing of a treatment unit 8 from the compartments 56, 256 by moving downward into contact with the bottom walls 258 when the top walls 257 are depressed, and then puncturing the bottom walls 258.

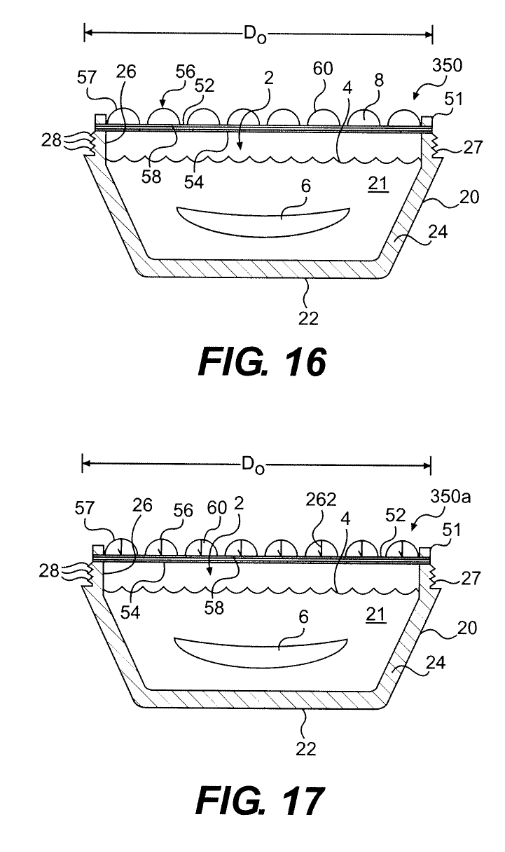

FIG. 16 illustrates a dispenser pack 350 according to another embodiment, wherein reference numbers repeated from the pack 50 (FIGS. 2 and 4) indicate similar features. The dispenser pack 350 is similar to the previously described dispenser pack 50, except that the outer diameter Dₒ of the dispenser pack 350 is selected such that the pack 350 rests on top of the lid engaging portion 26 of a container 20 (FIG. 2) and is sandwiched between the container 20 and a lid 40/140 (FIGS. 2 and 4/FIGS. 9 and 10) when the lid 40/140 is secured onto the container 20.

FIG. 17 illustrates a dispenser pack 350a for use with the lids 40, 140, according to yet another embodiment. The dispenser pack 350a is similar to the dispenser pack 50a (FIG. 14), as indicated by shared reference characters, except that the outer diameter Dₒ of the dispenser pack 350a is selected such that the pack 350a rests on top of the lid engaging portion 26 of a container 20 (FIG. 2) and is sandwiched between the container 20 and a lid 40/140 when the lid 40/140 is secured onto the container 20.

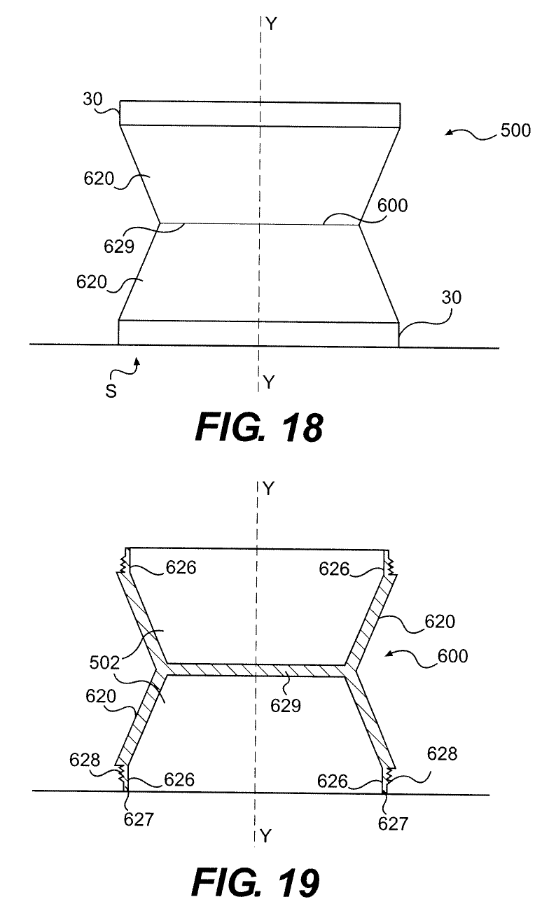

FIGS. 18 and 19 illustrate a contact lens case 500 according to yet another embodiment. The case 500 includes a base 600 having two containers 620 joined together by a central partition wall 629. Each container 620 includes an annular side wall 624 extending from the partition wall 629, and which combines with the partition wall 629 to define an internal reservoir or cavity 602 for holding solution 4 and a contact lens 6 in the solution 4. As shown in FIG. 19, a lid engaging portion 626 is defined at the top of the side wall 624. A plurality of external threads 628 are provided on an external side 627 of the lid engaging portion 626. The base 600 may be constructed of plastic, however other materials providing suitable weight, durability and rigidity may be used.

A lid assembly 30 may be attached to each container 620 in the same manner described with respect to the container 20 in the embodiment of FIGS. 1-7. The case 500 may be referred to as a “vertical lens case,” because the case is configured to rest on a surface S in a storage position, with either of the lids 40 supporting the case 500 on the surface S, and the containers 620 aligned with each other along a vertical axis Y. Thus, the containers 620 are vertically stacked when the case 500 is in a storage position, and the reservoirs 502 are disposed on vertically opposite sides of the partition wall 629. It is noted that the base 600 is not limited to use with the lid assemblies 30 described in the embodiment of FIGS. 18 and 19, but may also be used with any of the lid assemblies, lids and dispenser packs described in the other various embodiments herein.

The treatment units 8 to be administered to contact lenses 6 according to the various embodiments disclosed herein can be in powder, tablet, liquid or liquid emulsion form, and can contain any ophthalmic agent or compound that is used to treat any ocular disease or any ocular condition. Accordingly, the agent(s) in the units 8 can be selected from any class of compounds, for example, anti-inflammatory agents, anti-infective agents (including antibacterial, antifungal, antiviral, antiprotozoal agents), anti-allergic agents, antiproliferative agents, anti-angiogenic agents, anti-oxidants, neuroprotective agents, cell receptor agonists, cell receptor antagonists, immunomodulating agents, immunosuppressive agents, IOP lowering agents (anti-glaucoma), beta adrenoceptor antagonists, alpha-2 adrenoceptor agonists, carbonic anhydrase inhibitors, cholinergic agonists, prostaglandins and prostaglandin receptor agonists, AMPA receptor antagonists, NMDA antagonists, angiotensin receptor antagonists, somatostatin agonists, mast cell degranulation inhibitors, alpha-2 adrenoceptor antagonists, thromboxane A2 mimetics, protein kinase inhibitors, prostaglandin F derivatives, prostaglandin-2 alpha antagonists and muscarinic agents. It should be understood that while each of the units 8 may comprise the same active agent(s), it is possible to provide different active agents in individual units 8, as desired.

Of particular interest are pharmaceutical active agents that are known to treat an ocular disease or disorder including, but not limited to, a posterior-segment disease or disorder. In certain embodiments, such disease or disorder typically may include diabetic retinopathy, diabetic macular edema, cystoid macular edema, age macular degeneration (including the wet and dry form), optic neuritis, retinitis, chorioretinitis, intermediate and posterior uveitis and choroidal neovascuralization.

Glaucoma is a group of diseases that are characterized by the death of retinal ganglion cells (“RGCs”), specific visual field loss, and optic nerve atrophy. Glaucoma is the third leading cause of blindness worldwide. An intraocular pressure (“IOP”) that is high compared to the population mean is a risk factor for the development of glaucoma. However, many individuals with high IOP do not have glaucomatous loss of vision. Conversely, there are glaucoma patients with normal IOP. Therefore, continued efforts have been devoted to elucidate the pathogenic mechanisms of glaucomatous optic nerve degeneration.

It has been postulated that optic nerve fibers are compressed by high IOP, leading to an effective physiological axotomy and problems with axonal transport. High IOP also results in compression of blood vessels supplying the optic nerve heads (“ONHs”), leading to the progressive death of RGCs. See; e.g., M. Rudzinski and H. U. Saragovi, Curr. Med. Chem.—Central Nervous System Agents, Vol. 5, 43 (2005).

Pharmaceutical active agents that are prescribed by a physician for the treatment of glaucoma, and that may be formulated and disposed in the compartmentalized lens case for delivery to a contact lens and subsequently to the eye of a patient include travoprost, brimonidine, levobunolol, epinephrine, bitmatoprost, dipivefrin, carteolol and metipranolol.

In one embodiment, the anti-glaucoma pharmaceutical agent is of general formula II

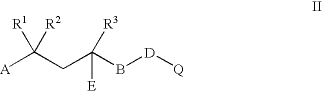

wherein A and Q are independently selected from the group consisting of aryl and heteroaryl groups substituted with at least a halogen atom, cyano group, hydroxy group, or C₁-C₁₀ alkoxy group; R¹, R², and R³ are independently selected from the group consisting of unsubstituted and substituted C₁-C₅ alkyl groups; B is a C₁-C₅ alkylene group; D is the —NH or —NR′— group, wherein R′ is a C₁-C₅ alkyl group; and E is the hydroxy group.

Exemplary, pharmaceutical agents of general formula II include A as a dihydrobenzofuranyl group substituted with a fluorine atom; Q as a quinolinyl or isoquinolinyl group substituted with a methyl group; R¹ and R² are independently selected from the group consisting of unsubstituted and substituted C₁-C₅ alkyl groups; B is a C₁-C₃ alkylene group; D is the —NH— group; E is a hydroxy group; and R³ is a trifluoromethyl group.

Exemplary compounds include a glucocorticoid receptor agonist having Formulae III or IV, as disclosed in US Patent Application Publication 2006/0116396.

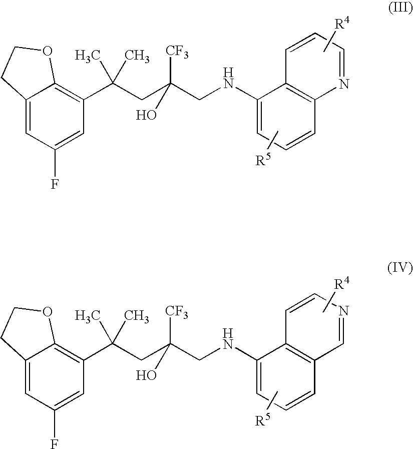

wherein R⁴ and R⁵ are independently selected from the group consisting of hydrogen, halogen, cyano, hydroxy, C₁-C₁₀ (alternatively, C₁-C₅ or C₁-C₃) alkoxy groups, unsubstituted C₁-C₁₀ (alternatively, C₁-C₅ or C₁-C₃) linear or branched alkyl groups, substituted C₁-C₁₀ (alternatively, C₁-C₅ or C₁-C₃) linear or branched alkyl groups, unsubstituted C₃-C₁₀ (alternatively, C₃-C₆ or C₃-C₅) cyclic alkyl groups, and substituted C₃-C₁₀ (alternatively, C₃-C₆ or C₃-C₅) cyclic alkyl groups.

Compositions of the invention also include ocular formulations prescribed by or recommended by a physician, or a health care provider, to treat ocular allergic conditions. Allergy is characterized by a local or systemic inflammatory response to allergens. Allergic conjunctivitis is a disorder that is characterized by the clinical signs and symptoms of eye itching, redness, tearing, and swelling. An estimated 20% of the population in the United States suffer from inflammation of the eye. The signs and symptoms of allergic conjunctivitis can significantly impact the quality of life of patients, from social interactions, productivity at work and school, to the ability to perform visual tasks such as working on a computer or reading.

Currently, available pharmaceutical treatments for inflammation of the eye or symptoms of inflammation of the eye include (1) antihistamines, (2) drugs that block the release of histamine and other substances from a mast cell (e.g., mast cell stabilizers), (3) drugs with multiple modes of action (e.g. antihistamine/mast cell stabilizing agents), and (4) drugs that can actively constrict blood vessels thus reducing redness and swelling (e.g., vasoconstrictors). Additionally, artificial tears have been used to wash the eye of allergens.

The desirability of a particular treatment for inflammation of the eye can be measured against the following factors (1) efficacy at onset of action, (2) duration of action, (3) efficacy at controlling signs and symptoms of allergic conjunctivitis, and (4) comfort of the drop when instilled in the eye.

Pharmaceutical active agents that are prescribed by a physician for the treatment of an ocular allergic condition, and that may be formulated and disposed in the compartmentalized lens case for delivery to a contact lens and subsequently to the eye of a patient include olopatadine, nedocromil, and lotepdrenol.

In one embodiment, the pharmaceutical active agent is ketotifen or a salt thereof. Ketotifen or any ophthalmically acceptable ketotifen salt may be used in the compartmentalized lens case herein described, although ketotifen fumarate is preferred. Ketotifen fumarate is represented by the following formula:

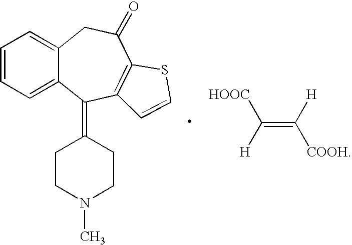

In another embodiment, the pharmaceutical active agent is an anti-redness agent, which may relieve redness in the eye. The preferred anti-redness agent is naphazoline or an ophthalmically acceptable salt thereof such as, for example, naphazoline hydrochloride. Other anti-redness agents that may be used include, but are not limited to, tetrahydrozoline, ephedrine, phenylephrine, oxymetazoline, xylometazoline, pseudoephedrine, tramazoline, other vasoconstrictors, combinations thereof, as well as ophthalmically acceptable salts thereof (e.g., tetrahydrozoline hydrochloride).

Naphazoline hydrochloride is represented by the following formula:

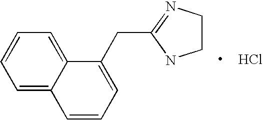

Naphazoline or a naphazoline salt may be present in a concentration from about 0.001% to about 0.2% (or alternatively, from about 0.001% to about 0.1%). In one embodiment, naphazoline or a naphazoline salt is present in a composition at a concentration from about 0.01% to about 0.1%; preferably, from about 0.01% to about 0.07%; more preferably, from about 0.02% to about 0.06%. In some embodiments, the method provides stability to compositions comprising naphazoline or a naphazoline salt in a concentration such that the concentration of naphazoline in the composition is about 0.02% to about 0.05%. Concentrations of a naphazoline salt yielding such concentrations of naphazoline base may be readily calculated; for example, using naphazoline hydrochloride in a concentration of about 0.025% in the composition provides a concentration of naphazoline base in the composition of 0.021%.

Additional information on formulations containing ketotifen, naphazoline or a corresponding pharmaceutically salt of each thereof can be found in U.S. patent application Ser. No. 10/972,571 filed Oct. 25, 2004.

Pharmaceutical active agents that are prescribed by a physician for the treatment of an ocular infection, and that may be formulated and disposed in the compartmentalized lens case for delivery to a contact lens and subsequently to the eye of a patient include antimicrobial agents, antibiotic agents and antifungal agents. The antimicrobial agents are selected from the group consisting of ciprofloxacin, sulfacetamide, trimethoprin, polymyxin B and norfloxacin. The antibiotic agents are selected from the group consisting of natamycin, tobramycin, gentamicin, gatifloxacin and ofloxacin. One of the more preferred antfungal agents is cromolyn.

Pharmaceutical active agents that are prescribed by a physician for the treatment of ocular inflammation, and which are formulated and disposed in the compartmentalized lens case for delivery to a contact lens and subsequently to the eye of a patient include stearoidal anti-inflammatory agents including dexamethasone, prednisolone, fluormetholone, medrysone, flurbiprofen and loteprednol. Alternatively, a non-steroidal anti-inflammatory agent such as ketorolac can be used with the compartmentalized lens case.

In yet another embodiment, cyclosporine can be formulated into stable emulsions and disposed in the compartmental lens case herein described. Cyclosporine is an immunosuppressive agent that is prescribed to patients with an ocular infection associated with keraconjunctivitis sicca. The cyclosporine is believed to act as a partial immunomodulator and enhances tear production.

In yet another embodiment, pharmaceutical active agents of the FK506 class can be formulated into stable emulsions and disposed in the compartmental lens case herein described. Emulsions, since they contain an aqueous phase, are much less occlusive than oil-based compositions and hence are better tolerated in many situations. Accordingly, in one embodiment a formulation, in the form of an emulsion, comprises a compound of the FK506 class, and a physiologically acceptable alkanediol, ether diol or diether alcohol containing up to 8 carbon atoms as solvent. A compound of the “FK506 class” is a compound which has the basic structure as FK506 and which has at least one of the biological properties of FK506 (e.g., immunosuppressant properties). The compound may be in free base form or pharmaceutically acceptable, acid addition, salt form. A preferred compound of the FK 506 class is disclosed in EP 427 680, e.g. Example 66a (also called 33-epi-chloro-33-desoxyascomycin).

In other embodiments, the agent(s) in treatment units 8 may include non-pharmaceutical ocular agents. For example, the units 8 may comprise agents such as lens rewetting agents, lubricating agents, moisturizing agents, alginate, HA [?], comfort agents, etc. The units 8 may also include disinfectant powders or tablets with rapid dissolution.

The foregoing disclosure provides illustrative embodiments and is not intended to be limiting. It should be understood that modifications of the disclosed embodiments are possible within the spirit and scope of the invention, and the invention should be construed to encompass such modifications.

We claim:

1. A contact lens case comprising:
a first container defining a first reservoir;
a first lid assembly comprising:
a first lid attachable to the first container for closing the first reservoir, and
a first dispenser pack attachable to the first lid or the first container; wherein the first dispenser pack comprises at least one first compartment containing a first treatment unit for dispensing into the first reservoir, the first treatment unit comprising at least one ophthalmic agent.

2. The contact lens case of claim 1, wherein the first at least one ocular treatment agent is selected from the group consisting of: anti-inflammatory agents, anti-infective agents, anti-allergic agents, antiproliferative agents, anti-angiogenic agents, anti-oxidants, neuroprotective agents, cell receptor agonists, cell receptor antagonists, immunomodulating agents, immunosuppressive agents, IOP lowering agents, beta adrenoceptor antagonists, alpha-2 adrenoceptor agonists, carbonic anhydrase inhibitors, cholinergic agonists, prostaglandins and prostaglandin receptor agonists, AMPA receptor antagonists, NMDA antagonists, angiotensin receptor antagonists, somatostatin agonists, mast cell degranulation inhibitors, alpha-2 adrenoceptor antagonists, thromboxane A2 mimetics, protein kinase inhibitors, prostaglandin F derivatives, prostaglandin-2 alpha antagonists and muscarinic agents.

3. The contact lens case of claim 1, wherein:
the first dispenser pack comprises an upper sheet of material defining a top wall of the at least one first compartment, wherein the first lid assembly is configured such that the top wall of the at least one first compartment is at least partially exposed at a top side of the first lid when the first dispenser pack is inserted into the first lid; and
the first dispenser pack comprises a lower sheet of material attached to the upper sheet of material and defining a rupturable bottom wall of the at least one first compartment, wherein the first lid assembly is configured such that the bottom wall of the at least one first compartment is at least partially exposed at bottom side of the first lid when the first dispenser pack is attached to the first lid.

4. The contact lens case of claim 3, wherein the upper sheet of material is constructed of transparent or translucent plastic, and wherein the lower sheet of material is constructed of foil or plastic.

5. The contact lens case of claim 3, wherein the top wall of the at least one first compartment is deformable such that the bottom wall of the at least one first compartment is rupturable by downward pressure applied to the top wall of the at least one first compartment and the first treatment unit.

6. The contact lens case of claim 3, wherein:
the at least one first compartment comprises a first puncturing element attached to the top wall of the at least one first compartment;
the top wall of the at least one first compartment is deformable; and
the first puncturing element is configured to travel downward to rupture the bottom wall of the at least one first compartment upon the application of downward pressure to the top wall of the at least one first compartment.

7. The contact lens case of claim 1, wherein the first dispenser pack comprises seven compartments for a weekly dosage schedule.

8. The contact lens case of claim 1, wherein the first lid comprises a retaining element extending from an interior surface of the first lid for securing the first dispenser pack to the first lid.

9. The contact lens case of claim 1, wherein the first dispenser pack comprises a peripheral edge and a gasket disposed at the peripheral edge.

10. The contact lens case of claim 1, comprising:
a second container defining a second reservoir;
a second lid assembly comprising:
a second lid attachable to the second container for closing the second reservoir, and
a second dispenser pack attachable to the second lid or to the second container; wherein the second dispenser pack comprises at least one second compartment containing a second treatment unit for dispensing into the second reservoir, the second treatment unit comprising a second at least one ophthalmic agent.

11. A contact lens case comprising:
a first container defining a first reservoir;
a first lid attachable to the first container for closing the first reservoir; wherein the first lid comprises at least one first compartment containing a first treatment unit for dispensing into the first reservoir.

12. The contact lens case of claim 11, wherein:
the first lid comprises an upper sheet of material defining a top wall of the at least one first compartment, wherein the top wall of the at least one first compartment is at least partially exposed at a top side of the first lid;
the first lid comprises a lower sheet of material attached to the upper sheet of material and defining a rupturable bottom wall of the at least one first compartment, wherein the rupturable bottom wall is at least partially exposed at bottom side of the first lid.

13. The contact lens case of claim 12, wherein the first upper sheet of material is constructed of transparent or translucent plastic, and wherein the first lower sheet of material is constructed of foil or plastic.

14. The contact lens case of claim 12, wherein the top wall of the at least one first compartment is deformable such that the bottom wall of the at least one first compartment is rupturable by downward pressure applied to the top wall of the at least one first compartment.

15. The contact lens case of claim 12, wherein:
the at least one first compartment comprises a first puncturing element attached to the top wall of the at least one first compartment;
the top wall of the at least one first compartment is deformable; and
the first puncturing element is configured to travel downward to rupture the bottom wall of the at least one first compartment upon the application of downward pressure to the top wall of the at least one first compartment.

16. The contact lens case of claim 11, comprising:
a second container defining a second reservoir;
a second lid attachable to the second container for closing the second reservoir, wherein the second lid comprises at least one second compartment containing a second treatment unit for dispensing into the second reservoir, the second treatment unit comprising a first at least one ophthalmic agent.

17. The contact lens case of claim 16, wherein the at least one first compartment and the at least second compartment each comprise seven compartments for a weekly dosage schedule to each eye.

18. A kit comprising:
a contact lens case comprising a first container defining a first reservoir, and a first lid attachable to the first container for closing the first reservoir, and
a plurality of dispenser packs, wherein each of the dispenser packs comprises a plurality of compartments that each contain a treatment unit comprising at least one ophthalmic agent, and wherein the dispenser packs are individually attachable to the first lid or the first container for dispensing the treatment units into the first reservoir.

19. The kit of claim 18, wherein the contact lens case comprises a second container defining a second reservoir, and a second lid attachable to the second container for closing the second reservoir, and wherein the dispenser packs are individually attachable to the second lid or to the second container for dispensing the treatment units into the second reservoir.

20. The kit of claim 19, comprising a packaged contact lens solution to be added to the first reservoir and the second reservoir.

21. A kit comprising:
a contact lens case comprising a first container defining a first reservoir and a second container defining a second reservoir; and
a plurality of lids, wherein each of the lids comprises a plurality of compartments that each contain a treatment unit comprising at least one ophthalmic agent, and wherein the lids are individually attachable to the first container and the second container.

22. A contact lens case comprising:
a container with a lid and defining a reservoir for containing a solution and a contact lens; and
a compartment formed by an upper wall and a lower wall on the lid and containing a treatment unit comprising at least one ophthalmic agent, the compartment being selectively rupturable to introduce the treatment unit into the reservoir.

23. The contact lens case of claim 22, wherein the compartment resides on or can be attached to the lid with a lid attachment.

24. The contact lens case of claim 22, wherein the lower wall is rupturable upon depression of the upper wall to release the treatment unit.
